(19) United States
(12) Patent Application Publication
(10) Pub. No.: US 2014/0039999 A1
(43) Pub. Date: Feb. 6, 2014

(54) SYSTEM AND METHOD FOR MERCHANTS TO CHARGE FEES TO BUYERS FOR CREDIT CARD AND DEBIT CARD TRANSACTIONS

(71) Applicants: Edward R. Levene, New Canaan, CT (US); Robert S. Levene, Weston, CT (US)

(72) Inventors: Edward R. Levene, New Canaan, CT (US); Robert S. Levene, Weston, CT (US)

(21) Appl. No.: 13/841,847

(22) Filed: Mar. 15, 2013

Related U.S. Application Data
(60) Provisional application No. 61/678,368, filed on Aug. 1, 2012.
(60) Provisional application No. 61/749,183, filed on Jan. 4, 2013.

(51) Int. Cl. G06Q 20/08

(52) U.S. Cl. CPC G06Q 20/0855
USPC 705/14.23; 705/39; 705/16; 705/44

(57) ABSTRACT

System and method for calculating and applying surcharges or payment type fees to payment transactions. A calculation device receives pricing and payment information for a transaction, such as a credit or debit card transaction, and calculates a surcharge or payment type fee based upon the transaction costs that will apply if the transaction is completed. The transaction costs may be estimated by the calculation device or received from a payment network.

### FIELD OF THE INVENTION

The invention relates to payment transactions, such as credit or debit card transactions, and more specifically to a system and method for calculating and applying a surcharge or discount to a purchase price when a payment method is used.

### BACKGROUND OF THE INVENTION

Since the introduction of payment cards, such as credit and debit cards, their use has revolutionized commerce. Consumers need no longer carry cash, and may make purchases with preapproved lines of revolving credit. The use of payment cards has also simplified remote transactions by obviating banknotes, enabling the boom in internet sales that has reshaped commerce in recent years.

Because of the importance of non-cash payment methods, such as payment cards merchants have a strong incentive to facilitate these payment transactions.

Unfortunately, facilitating such payment transactions comes at a cost for the merchant. A typical payment card transaction requires communicating transaction information among a number of different entities, each of which charges for this service. For example, after receiving payment card account information from a customer, a merchant transmits this information along with the price of goods and/or services to the card issuing bank through one or more intermediaries. The intermediaries may include an acquiring bank, gateway, Independent Sales Organization (“ISO”), merchant acquirer, and/or processor. Any or all of these entities may be party to a card association, such as Visa™ or MasterCard™. Any of these entities will charge a processing fee for their involvement in the transaction. For example, the card association and issuing bank will charge an interchange fee, and an ISO will charge a merchant fee in addition to the interchange fee. Other such payment methods have a fee to process and potentially additional fees to guarantee payment.

Until recently, these fees have been ultimately passed on to the merchant, who has been prohibited from directly charging the customer for these fees under their agreements with credit card networks, and under certain laws. Accordingly, merchants may choose to support only those cards requiring the lowest transaction fees. In this case, consumers cannot take advantage of incentive programs offered by the unsupported payment methods, and the effectiveness of such incentive programs to drive consumers to use a particular payment method may be reduced.

However, changes in the restrictions on merchants under their agreements with certain credit card networks have recently freed merchants to pass on these costs in the form of a surcharge, where not prohibited by law.

Now, with the ability to pass transaction fees on to customers, merchants, acquirers, credit and debit card entities and other types of payment processors have a way to drive customers to their products and to incentivize the use of particular cards or payment forms, if desired.

In order to directly incentivize the customer to select a particular payment method based on the transaction costs, at least a part of these costs must be presented to the customer prior to the completion of the transaction.

For example, if a customer tenders a particular payment method for use in a transaction and is presented with the transaction fees, the customer may decide to choose a different payment product or payment method if the cost is too high. On the other hand, the customer may choose to accept a higher fee if the incentive program offered by the payment method is attractive enough.

The merchant may also wish to incentivize the use of particular payment method pursuant to marketing agreements or other business arrangements. In this case, the merchant may wish to absorb all, or a part of the transaction fee, or to offer rewards points or a discount to be combined with and offset or eliminate the payment type fee or surcharge. The merchant may also wish to permit the consumer to defray the processing costs by agreeing to view advertising or to participate in surveys and the like, where this is advantageous to the merchant.

However, presenting a payment type fee, surcharge or discount to the customer based upon transaction fees prior to the completion of the transaction is not a straightforward process. This is at least partly because the transaction fees involved may not be fully known until after the settlement of the transaction.

Accordingly, it would be advantageous to provide a system and method for applying a payment type fee or surcharge to a purchase price when payment is made that addresses these difficulties.

There have been earlier attempts to influence consumer behavior and defray transaction costs to the merchant.

U.S. Pat. No. 7,882,028 to Devine discusses calculating or predicting merchant fees based upon characteristics of a credit card transaction. Merchant fees may be calculated based upon prior transaction data. A merchant may request rejection of the transaction based upon the calculated merchant fee.

U.S. Pat. No. 6,601,037 to Kolls discusses offsetting a processing fee associated with a transaction by displaying advertising to the consumer and offsetting the transaction cost using advertising revenue.

U.S. Patent Application Publication No. 2012/0323669 to Kohlmeier relates to offering a consumer an incentive to switch payment methods. Various payment methods available for a given transaction, e.g. different credit cards, may be analyzed to determine the transaction cost to the merchant. If the consumer selects a credit card brand which charges a higher average transaction fee to the merchant, the consumer is offered an incentive to switch to a different credit card which charges the merchant a lower transaction fee. For example, if the transaction cost difference is $0.50, the consumer is offered $0.25 to switch.

U.S. Patent Application Publication No. 2012/0323667 to Groff et al. discusses a system for associating discounts with payment options. A customer may present goods or services to a merchant for payment using a point of sale system. The point of sale system accesses an undisclosed database to determine the transaction costs associated with various forms of payment for the mix of goods and services. The customer is then presented with one or more options for payment, including any discounts based on the form of payment. The discounts may be based on the cost to the merchant for different forms of payment, and may be ranked for the customer. The discounts may be applied on a fixed, percentage, or per-unit basis.

U.S. Patent Application Publication No. 2012/0215601 to McGuire discusses discounting prices paid by a consumer based upon tasks performed by the consumer. For example, the consumer may be offered a discounted price in exchange for viewing an advertisement, answering a question, participating in a survey, and so forth. The decreased price may be offered to other consumers, who can decrease the price further by completing tasks.

U.S. Patent Application Publication No. 2011/0313895 to Choi et al. discusses a merchant referral method, whereby a referring merchant's transaction fees are defrayed by a referral credit that is based upon a referred merchant's transaction volume or fees.

U.S. Patent Application Publication No. 2008/0275771 to Levine discusses displaying advertisements to consumers on a transaction record, such as a paper or electronic receipt. In particular, the reference discusses targeting the advertising to consumers by analyzing the authorization request or consumer data for information relating to credit limits and other criteria. The advertising revenues may be applied to offset the merchant's transaction costs.

However, none of these references provides for calculating a payment type fee or surcharge to the customer. Furthermore, none of these references provides a useful method for calculating the cost of acceptance of a specific card that was unknown to the merchant prior to it being provided for payment to the merchant for a transaction.

What is desired therefore is a payment method calculation and surcharging or payment type fee system that overcomes these deficiencies.

### SUMMARY OF THE INVENTION

Accordingly, it is an object of the invention to provide a system and method for calculating a payment type fee or surcharge to a customer for a payment transaction.

It is another object of the invention to calculate a payment type fee or surcharge based upon a transaction cost of a payment transaction.

It is a further object of the invention to calculate a payment type fee or surcharge which defrays a transaction cost to a merchant of a payment transaction.

These and other objects are achieved by providing a payment surcharging system or payment type fee system which includes a calculation device; and, a client device configured to receive a price for a transaction and receive payment information; transmit the price and the payment information to the calculation device; receive the payment type fee or surcharge information from the calculation device that is determined based upon the price and the payment information; and, determine a payment type fee or surcharge based on the payment type fee or surcharge information.

In some implementations, the client device receives the price and payment information from a customer, and provides the payment type fee or surcharge to the customer for approval.

In some implementations, the calculation device calculates the payment type fee or surcharge information based on a transaction cost.

In some implementations, the calculation device calculates the payment type fee or surcharge information based on an estimated transaction cost.

In some implementations, the calculation device calculates an estimated transaction cost.

In some implementations, the calculation device calculates the payment type fee or surcharge information based on a historical transaction cost.

In some implementations, the calculation device calculates the payment type fee or surcharge information based upon a statistical analysis of a plurality of historical transaction costs.

In some implementations, the calculation device calculates the payment type fee or surcharge as an average of at least two historical transaction costs.

In some implementations, the calculation device calculates the payment type fee or surcharge as a median of at least three historical transaction costs.

In some implementations, the calculation device receives an actual transaction cost for the transaction and calculates the payment type fee or surcharge based upon the actual transaction cost.

In some implementations, the calculation device communicates the price to a network computer and receives actual transaction costs from the network computer prior to calculating the payment type fee or surcharge.

In some implementations, the calculation device receives at least a portion of an actual transaction cost for the transaction and calculates at least a portion of the payment type fee or surcharge based upon the portion of the actual transaction cost.

In some implementations, the calculation device calculates the payment type fee or surcharge information based on a percentage of the price.

In some implementations, the calculation device calculates the payment type fee or surcharge information based on a fixed percentage of the price.

In some implementations, the calculation device calculates the payment type fee or surcharge information based upon a metric selected from the group consisting of an interchange rate; an interchange rate category; an interchange fee; a merchant discount rate; a merchant discount fee; a calculation rate; a calculation fee.

In some implementations, the calculation device calculates the payment type fee or surcharge information based upon a metric selected from the group consisting of a merchant billing address; a merchant physical location; a merchant classification code; a merchant services provider contract; an acquiring bank contract; a gateway contract; an annual transaction volume.

In some implementations, the calculation device is integrated with the authorization device.

In some implementations, the calculation device is configured to communicate with the authorization device over a network.

In some implementations, the calculation device is configured to communicate with the authorization device over the Internet.

Other objects of the invention are achieved by providing a method for charging a payment type fee or surcharging a payment transaction which includes providing a calculation device; and, providing a client device configured to receive a price for a transaction and receive payment card information; transmit the price and the payment information to the calculation device; receive payment type fee or surcharge information from the calculation device that is determined based upon the price and the payment information; and, determine a payment type fee or surcharge based on the payment type fee or surcharge information.

Further objects of the invention are achieved by providing a payment payment type fee or surcharging system which includes a calculation device having a processor and a memory and which is configured to calculate a payment type fee or surcharge information based upon a price, payment information, and a transaction cost; and, a client device which includes a second processor and a second memory, which is configured to communicate with the calculation device and to receive the price and payment information from a customer; transmit the price and the payment information to the calculation device; receive a payment type fee or surcharge information from the calculation device; and, determine a payment type fee or surcharge based on the payment type fee or surcharge information.

Other objects of the invention and its particular features and advantages will become more apparent from consideration of the following drawings and accompanying detailed description.

### BRIEF DESCRIPTION OF THE DRAWINGS

FIG. 1 is a flow chart illustrating an example system according to the invention.

FIG. 2 is a schematic diagram showing an example implementation of the system shown in FIG. 1.

FIG. 3 is schematic diagram showing an example implementation of the system shown in FIG. 1.

FIG. 4 is a schematic diagram showing an example implementation of the system shown in FIG. 1.

FIG. 5 is a flow chart showing the example system according to the invention shown in FIG. 1, illustrating additional features.

FIG. 6 is schematic diagram showing an example implementation of the system shown in FIG. 5.

FIG. 7 is schematic diagram showing an example implementation of the system shown in FIG. 5.

FIG. 8 illustrates an example customer interface with the system shown in FIG. 1, according to aspects of the invention.

FIG. 9 illustrates an example merchant interface with the system shown in FIG. 1, according to aspects of the invention.

FIG. 10 illustrates an example method which may be implemented using the system shown in FIG. 1, according to aspects the invention.

FIG. 11 illustrates the example method of FIG. 10, including additional steps, which may be implemented using the system shown in FIG. 1, according to aspects of the invention.

### DETAILED DESCRIPTION OF THE INVENTION

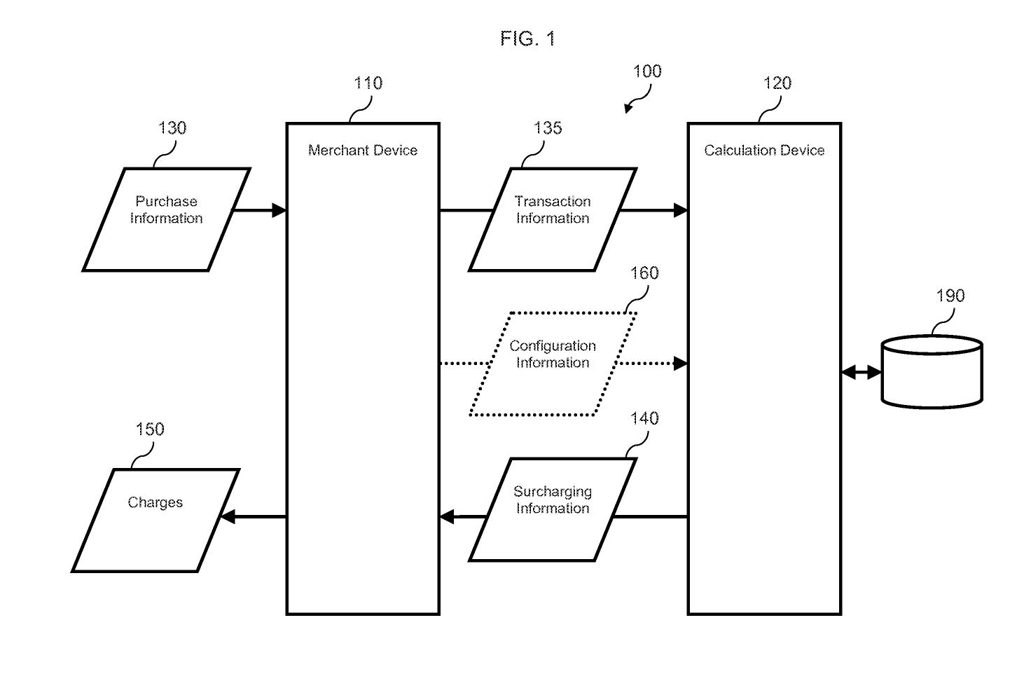

FIG. 1 illustrates an example system 100 according to aspects of the invention.

System 100 includes a merchant device 110 and a calculation device 120. Merchant device 110 receives purchase information 130 from a customer during a transaction, and transmits transaction information 135 to calculation device 120.

Calculation device 120 receives transaction information 130 from merchant device 110, calculates a payment type fee or surcharging information 140 based on at least part of the transaction information, as further described herein, and transmits surcharging information 140 to merchant device 110.

Merchant device 110 receives a payment type fee or surcharging information 140 from calculation device 120, and outputs a charge 150.

Merchant device 110 may include any suitable device capable of receiving purchase information 130 and transmitting transaction information 135, receiving payment type fee or surcharging information 140, and outputting charges 150. For example, merchant device 110 may include a point-of-sale terminal or a similar device used by a merchant when processing transactions with a customer in person, and may receive payment method and price information directly via any known input/output device such as a card reader, keypad, RFID transceiver, optical scanner, and the like. Optionally, merchant device 110 may be a device which can communicate with such a point-of-sale terminal. Alternately, merchant device 110 may be a computer server, terminal, or other suitable computing device, such as a web server used by a merchant when processing transactions from a customer computer over the internet via a web shopping cart or other suitable interface. In some implementations, merchant device 110 may include software stored on a non-transient computer-readable medium, and a processor which may execute the software to provide some or all of the functions of merchant device 110. In some implementations, merchant device 110 may include a smart phone.

Purchase information 130 includes a price of goods and/or services that a customer desires to purchase from the merchant. In some implementations, the price may optionally include any taxes, shipping, handling, additional fees, coupon discounts, or other adjustments applied by the merchant.

Purchase information 130 also includes information relating to a payment account, such as a credit or debit card number or other type of account identification. The payment card account information may also include other information specific to a payment account, such as the name of the account holder, customer signature, address verification, security code, or other information related to a payment transaction.

Transaction information 135 includes or is derived from purchase information 130. Optionally, instead of a full account number, card information included in transaction information 130 includes only a Bank Identification Number (“BIN”) representing a payment card brand, issuing bank, and card product. The BIN may include or consist of the first six digits or more numbers of a payment card number supplied as purchase information 130. In implementations where the payment type fee or surcharge is calculated based only on card type and brand information or other type of account information, rather than based on a specific account, this can have the advantage of improving security by permitting the payment type fee or surcharge information to be calculated without transmitting more sensitive data.

Transaction information 135 may include other information used for calculating payment type fee or surcharging information 140, including the merchant name and billing address; merchant's physical locations; card brands and other payment types accepted; merchant classification code registered with each card brand accepted by merchant; merchant services provider name; merchant service provider contract pricing details; acquiring bank(s); contract pricing agreements with acquiring bank(s); gateway (if used); contract pricing agreements with gateway (if used); annual transaction volume for each card brand accepted; average merchant discount rate; average other merchant services monthly fees; authorization to receive copies of transaction settlement information from merchant's merchant services provider; state and local sales tax rates for each merchant location; card acceptance methods (swiped, key entered, card not present); merchant UCAF (universal cardholder authentication field) implementation; address verification utilization; CCV code verification utilization; merchant surcharge/discount/rewards points configuration; merchant surcharge threshold fixed segment configuration (thresholds identify the separating line between when the cost of processing a particular transaction is either high enough for the merchant to add a checkout charge proportional to how much the cost of processing is above the threshold or low enough to provide a checkout discount proportional to how much the cost of processing the transaction is below the threshold. The threshold can consist of either a fixed dollar amount regardless of the transaction initial total, or a fixed percentage of the transaction initial total, or a combination of both a fixed dollar amount (segment) and a fixed percentage (segment).); merchant payment type fee or surcharge threshold percentage segment configuration; merchant discount threshold fixed segment configuration; merchant discount threshold percentage segment configuration; merchant payment type fee or surcharge passthrough percentage configuration; merchant discount passthrough percentage configuration; merchant rewards points; pointsvalue configuration; merchant's calculation device identification number (where the calculation device refers to the system for calculating payment type fee or surcharges, and the identification number identifies the merchant to the system); merchant's location identification number; transaction subtotal; transaction sales taxes; transaction initial total; payment card bank identification number (the bin is the first 6 digits or more of the card number for Mastercard, Visa, Discover, and American express); products and services information indicating the type of products or services that comprise the transaction; configuration adjustment information (if the calculation device merchant configuration for this particular transaction is to be modified by calculation device for the current transaction from the default or preconfigured merchant configuration.)

Transaction information 135 may further include a subtotal (sum of charges for all products and services included in the transaction prior to the application of sales taxes); sales taxes other charges consisting of any shipping, handling, or other fees (not including any checkout discounts or checkout payment type fees or surcharges as calculated and recommended by calculation device); initial total, consisting of the transaction total as calculated by the merchant checkout software prior to receiving the results of a cost of acceptance calculation.

Any or all of these elements of transaction information 135 may be calculated by merchant device 110 based on the purchase information 130 where appropriate.

Transaction information 135 is used by calculation device 120 to generate a payment type fee or surcharging information 140 in various ways.

In some implementations, calculation device 120 may include any suitable device capable of receiving transaction information 135, and calculating and transmitting a payment type fee or surcharging information 140. For example, calculation device 120 may include a computer server or other suitable computing device, and may be in communication with a database 999. In some implementations, calculation device 120 may include software stored on a non-transient computer-readable medium, and a processor which may execute the software to provide some or all of the functions of calculation device 120. In some implementations, merchant device 110 may be considered to be a client of calculation device 120.

Calculation device 120 may calculate a payment type fee or surcharging information 140 based upon transaction information 135 in any way described herein, according to the desired implementation.

For example, a payment type fee or surcharging information 140 may include a total of the actual transaction costs that would be incurred by completing the transaction, as further described herein. This can have the advantage of permitting accurate cost recovery to the merchant in cases where the actual transaction costs, such as interchange fees and ISO merchant fees, are known prior to the completion of the transaction.

A payment type fee or Surcharging information 140 may include a payment type fee or surcharge calculated as a fixed percentage of the price of the goods and/or services purchased in the transaction, or as a tiered, increasing (progressive), or decreasing (regressive) percentage of the price of the goods and/or services, optionally including a cap and/or marginal rate. Optionally, the payment type fee or surcharging information may be calculated using a combination of the foregoing. These approaches may have the advantage of providing a reasonable approximation of actual transaction costs for calculating payment type fees or surcharging information 140 without incurring added costs or complexity to determine the actual transaction costs in advance of the completion of the transaction.

Payment type fees or surcharging information 140 may include a payment type fee or surcharge calculated as an average, median, mode, or other function or statistical analysis of the historical costs of similar transaction types, for the specific payment brand tendered, for the specific payment type tendered, or of all of these. These approaches may have the advantage of providing a reasonably accurate approximation of actual transaction costs for calculating payment type fee or surcharging information 140 in implementations where it is impossible or undesirable to determine the actual transaction costs in advance of the completion of the transaction. These approaches also permit iterative refinement of transaction cost estimates by logging the actual transaction costs after each completed transaction.

Payment type fees or surcharging information 140 may include a payment type fee or surcharge that is calculated using a combination of any the approaches described herein. For example, in an implementation where the actual transaction cost attributable to the interchange fee is known, but where the actual transaction cost attributable to an ISO merchant fee is unknown, the payment type fee or surcharge may include a sum of the actual interchange fee and an estimated ISO merchant fee calculated using any of the approaches discussed herein.

Some types of information relating to calculating payment type fees or surcharges may be updated or transmitted to calculation device 120 in advance of a transaction, or at an arbitrary time. For example, in some optional implementations, information that remains constant for most transactions may be preconfigured by the merchant as configuration information 160. Configuration information 160 may include any of the information described herein as transaction information 135, such as the merchant location, or other information that may bear upon the calculation of surcharging information 140 as further described above.

Any or all of the above payment type fee or surcharging calculations may be employed as desired by the merchant, and may be configured using configuration information 160 and/or transaction information 135.

Merchant device 110 receives the payment type fee or surcharging information 140, and outputs a charge 150 based upon surcharging information 140 and the price of the goods and/or services.

Charge 150 may simply be the total of the price and a payment type fee or surcharge provided as or with the payment type fee or surcharging information 140. Depending on the desired implementation, Charge 150 may optionally include additional charges, credits, or other offsets. For example, the merchant may wish to add an additional fee or percentage of the purchase price in addition to a payment type fee or surcharge provided in the payment type fee or surcharging information 140. Alternatively, the merchant may wish to offset the payment type fee or surcharge to the customer as part of a promotion. For example, the merchant may offer reduced or eliminated payment type fees or surcharges for a particular good or service in order to encourage sales, or in return for an agreement to view advertising information, to complete a survey, or to provide marketing or other data. The merchant may also offer reduced, eliminated, or increased payment type fees or surcharges for a particular payment type or brand, according to a marketing arrangement, or to encourage the use of a merchant branded payment type. Payment type fees or surcharge modifications may be applied for other reasons, such as depending on payment type, e.g. credit, debit or check, or depending on the time of the transaction, for example, in order to encourage or discourage the use of different categories of payment or to influence consumer behavior with respect to various factors. In some implementations, this information is not presented as a total, and is presented separately to the consumer. For example, the price and payment type fee or surcharge may be presented to a customer as separate quantities.

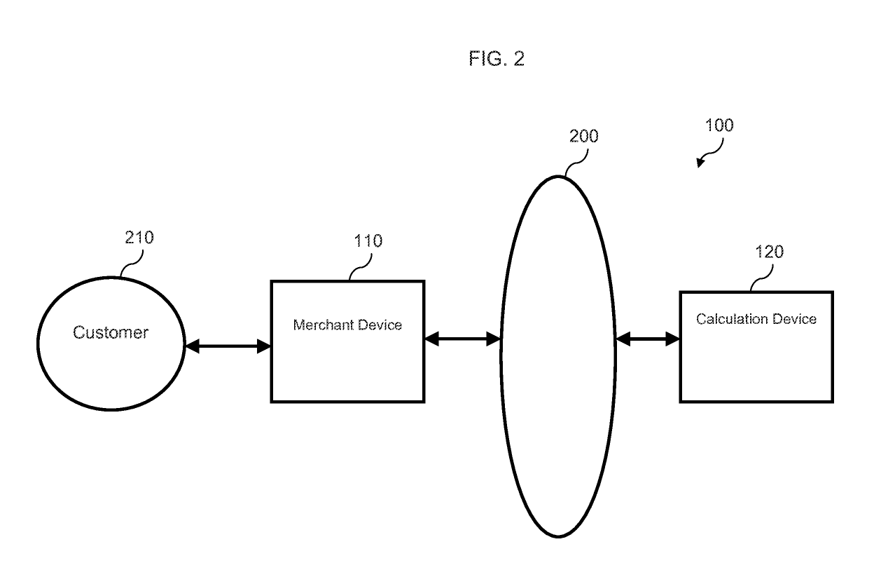

FIG. 2 illustrates an example configuration of system 100, which may be used, for example, where a customer 210 provides transaction information (130 as shown regarding FIG. 1) to a merchant device 110 that is provided at a point of sale, for example, by scanning merchandise bar codes and swiping a credit card. The merchant device 110 subsequently outputs a total (150 as shown regarding FIG. 1). Merchant device 110 communicates with calculation device 120 as shown and described in relation to FIG. 1, or as otherwise described herein. The configuration shown in FIG. 2 may be appropriate, for example, where the merchant device is located at a retail store, and the calculation device is provided remotely as part of a third-party service.

Communications between Merchant device 110 and calculation device 120 take place over a computer communications network 200. Computer communications network 200 may include any suitable communications network, such as the Internet or a subset thereof, a private and/or proprietary network, cellular telephone network, LAN, or a combination of any of these.

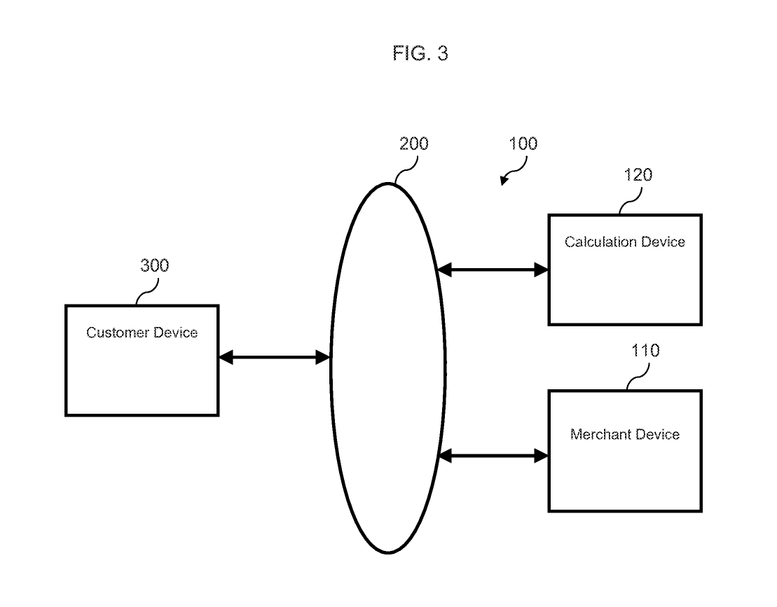

FIG. 3 illustrates another example configuration of system 100, which may be used, for example, where merchant device 110 includes or is a part of an online shopping website, and where the calculation device 120 is provided remotely as part of a third-party service.

Communications between merchant device 110 and calculation device 120 take place over a computer communications network 200. Transaction information (130 as shown regarding FIG. 1) is provided to the merchant device 110 over network 200 using a customer device 300. Customer device 300 may be any suitable device capable of communicating with merchant device 110, such as a personal computer, smart phone, web appliance, or other device featuring a web browser or other suitable client software or hardware.

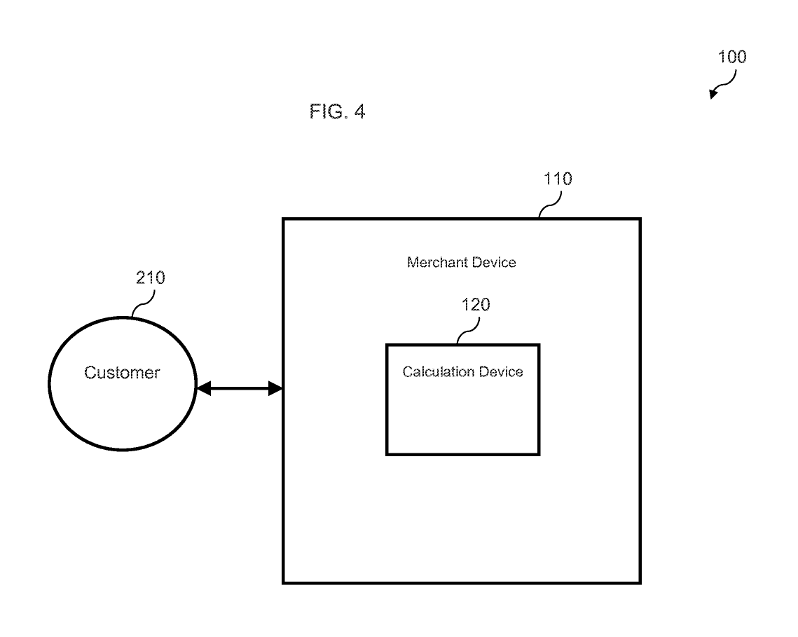

FIG. 4 illustrates a further example configuration of system 100. In the configuration of FIG. 4, calculation device 120 is a subsystem of, or is otherwise integrated into merchant device 110. This configuration may be used in an implementation where merchant device 110 is present to the customer 210 at the point-of-sale, or where the customer 210 communicates with merchant device 110 via a computer network (not shown), such as in a web-based transaction.

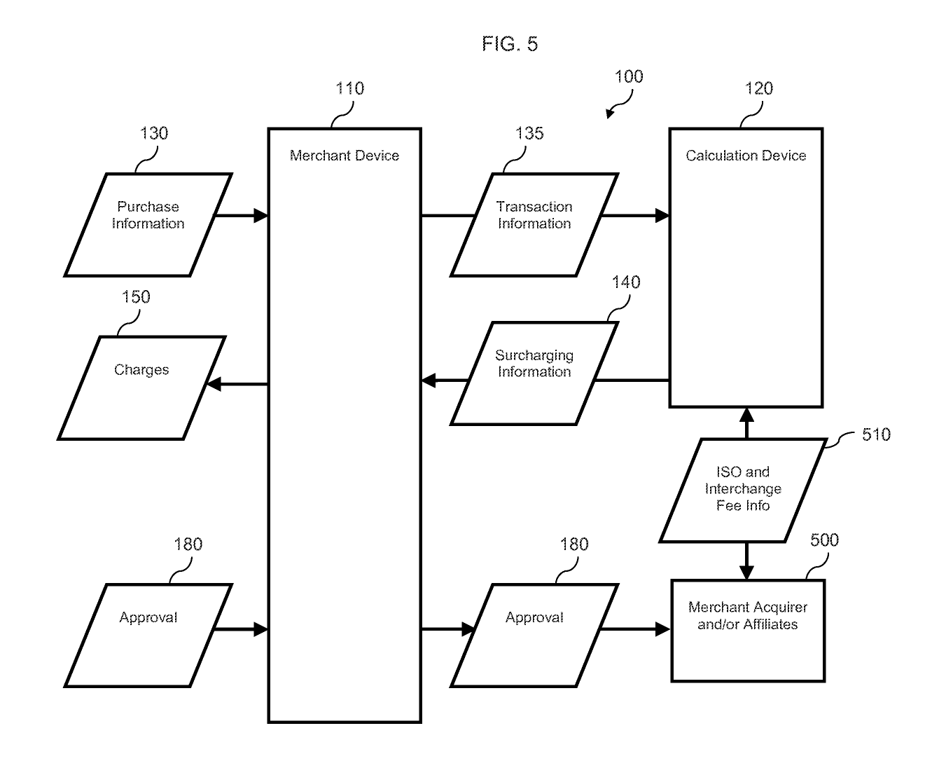

FIG. 5 illustrates system 100, including additional features. As illustrated in FIG. 5, a merchant acquirer and/or its affiliates 500, such as an ISO, can communicate with calculation device 120 to provide ISO and/or interchange fee information 510. As discussed herein, calculation device 120 may use such information to calculate payment type fee or surcharging information 140. Optionally, calculation device 120 may provide transaction information to the merchant acquirer and/or its affiliates, and the ISO and/or interchange fee information 510 may be the exact ISO and/or interchange fees that would apply to the transaction information 135. After merchant device 110 provides charge 150, merchant device 110 can receive an approval 180 of the total, and transmit this total to a merchant acquirer and/or its affiliates 500 for processing. Those having skill in the art will appreciate that there may be various permutations of this arrangement. For example, a merchant acquirer (not shown) other than an ISO may be used in the same way to provide fee information to calculation device 120 and to receive approval of charge 150 for processing.

Any of these communications may take place over a suitable computer communications network (not shown) such as the Internet or a subset thereof, a private and/or proprietary network, cellular telephone network, LAN, or a combination of any of these.

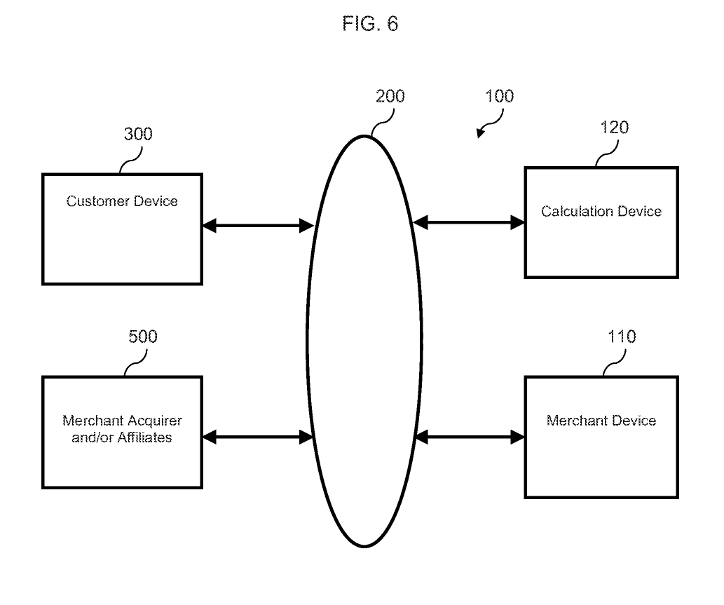

FIG. 6 illustrates another example configuration of system 100 where the communications among a customer device 300, calculation device 120, merchant device 110, and ISO 500 take place over network 120.

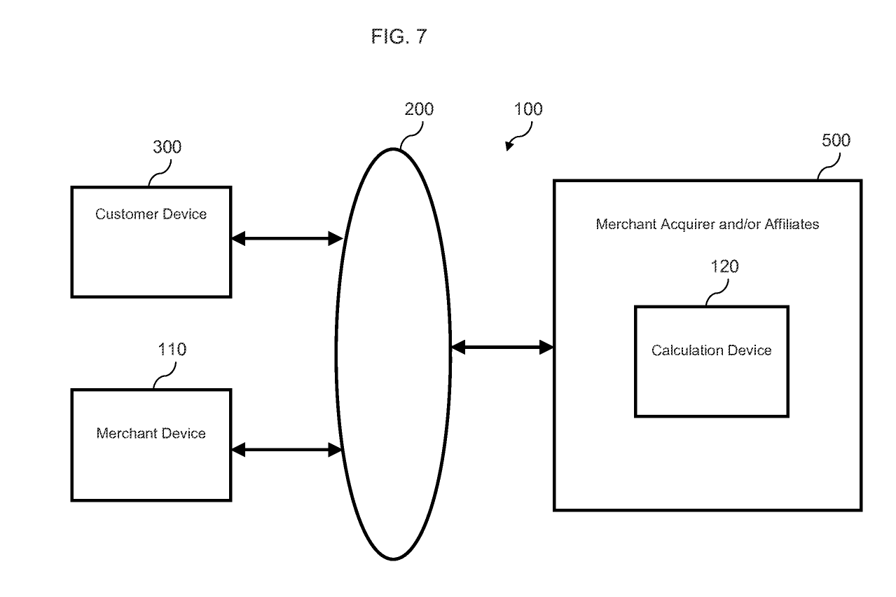

FIG. 7 illustrates a further example configuration of system 100 similar to that shown in FIG. 6, except that calculation device 120 is a subsystem of or otherwise integrated into ISO 500. This configuration may be used in an implementation where ISO 500 provides payment type fee or surcharge calculation services to merchants. Similarly, those having skill in the art will note that a merchant acquirer (not shown) other than ISO 500 may also include or implement calculation device 120 for the same purpose.

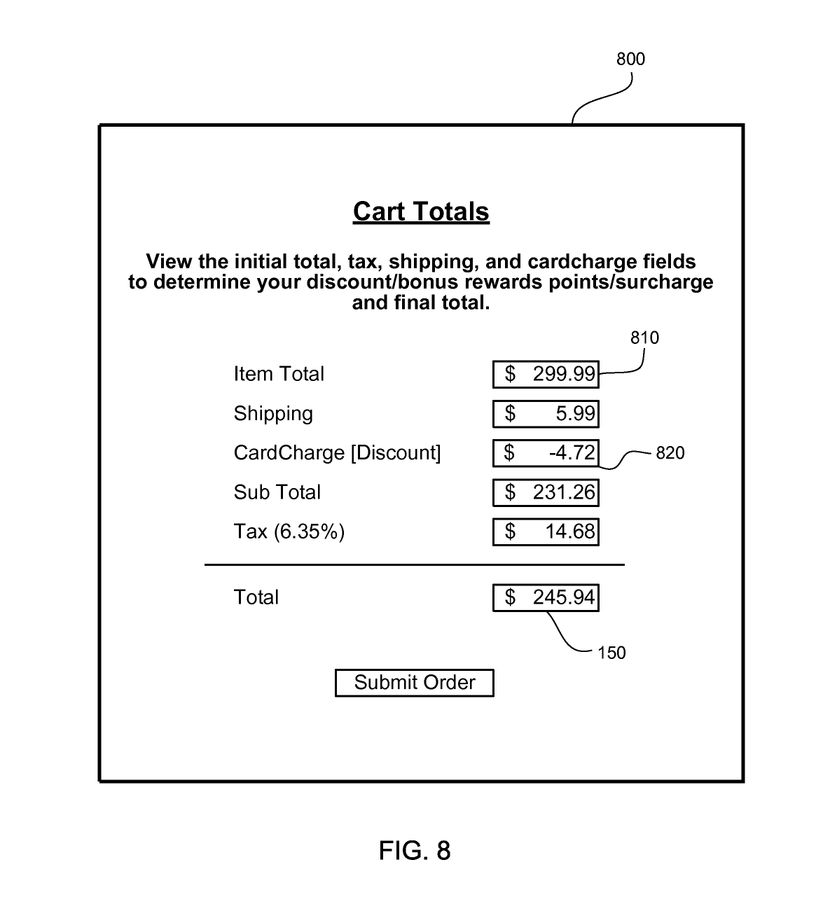

FIG. 8 illustrates an example charge confirmation interface 800 according to aspects of the invention. Interface 800 presents charge 150 to a customer. Interface 800 may also provide other information to the user, such as the components of charge 150. For example, item total 810 may be a total price of goods and/or services tendered by a customer for purchase, and may be a quantity included in transaction information 135 (FIG. 1). Net surcharge or payment type fee 820 reflects the net surcharge or payment type fee to the customer based upon surcharging or payment type fee information 140 (FIG. 1).

Net surcharge or payment type fee 820 is shown in FIG. 8 as a negative number. This illustrates the use of additional offsets by the merchant as further described herein. For example, in a case where the transaction costs to the merchant due to interchange and other fees are ordinarily passed on to the customer, an offset, such as a promotion for the use of a particular card or the sale of a particular service may offset or fully cancel the transaction costs. Here, such an offset exceeds the transaction costs, resulting in a negative net surcharge or payment type fee 820 to the customer.

Such offsets may be calculated by the merchant device 110 (e.g. FIG. 1), or may be configured to be applied by the calculation device 120 (e.g. FIG. 1), depending upon the desired implementation.

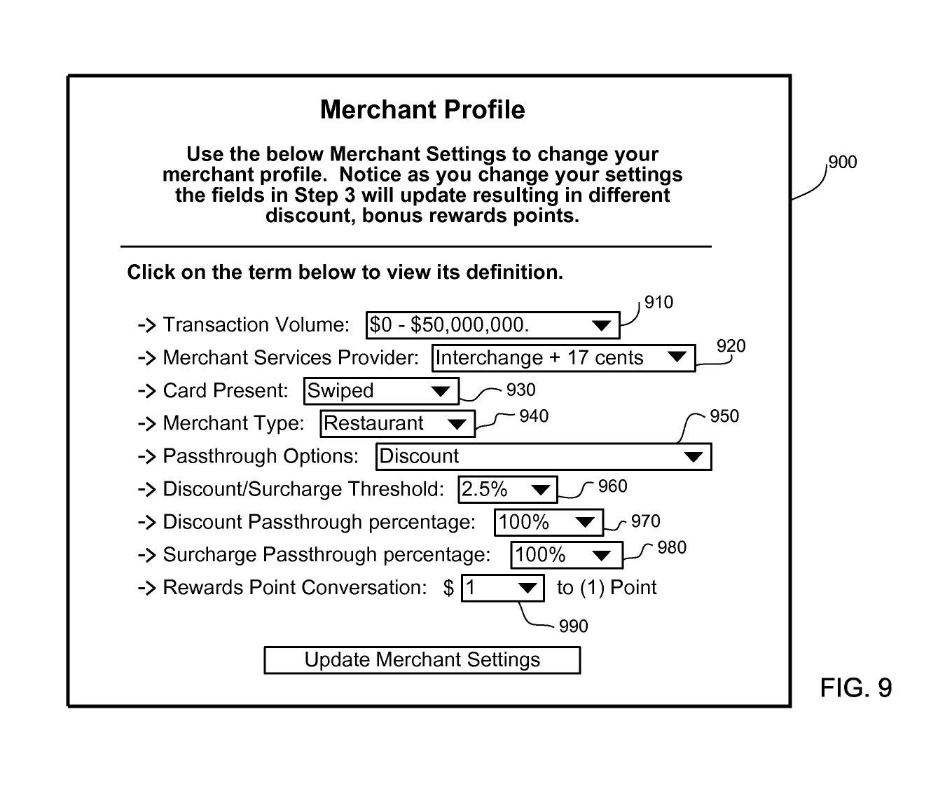

FIG. 9 illustrates an example configuration interface 900 according to aspects of the invention. Configuration interface 900 may be used to provide configuration information 160 (FIG. 1). As discussed further herein, merchants may wish to provide configuration information 160 to the calculation device in order to preset information that is unlikely to change with each transaction. This can have the advantage of reducing the amount of information that must be included in transaction information 135 (FIG. 1).

In this example, instructions for calculating surcharge or payment type fee information 140 (FIG. 1) may be specified with interface 900 using the merchant device 110 (FIG. 1) or another suitable interface, such as a web interface.

In the example configuration information reflected in FIG. 9, a transaction volume 910 is specified as between $0 and $50,000,000. Transaction volume 910.

Merchant services provider fees 920 are specified to be calculated as interchange plus 17 cents. This means that the calculation device will calculate a surcharge or payment type fee, in this example, by estimating that the portion of the transaction fees attributable are equal to the interchange rate for the transaction plus an additional fee. Other possible options will be clear to those having skill in the art.

Card present status 930 is specified here as Swiped. Card present status has an effect on the transaction fees charged for a transaction. For example, the transaction fees may be higher for a card-not-present transaction, such as a web purchase. In this case, the merchant has configured the calculation device to presume that the card is swiped for all transactions. Other possible options for card present status 930 include “card not present”, check or electronic check.

Merchant type 940 is specified here as “Restaurant”. Merchant type is a classification which also may have a bearing on how the transaction fees are calculated. For instance, interchange fees may be lower for a restaurant than for another type of merchant.

Passthrough Options 950 are specified here as “Discount”. This means that for the configuration specified in interface 900, only discounts will be passed through to the customer. In this configuration, the merchant has elected to absorb calculated transaction charges without passing them on as a part of the surcharge or payment type fee. Other options may include surcharge or payment type fee, surcharge or payment type fee+discount, and “none”.

Discount/Surcharge Threshold 960 is specified here as 2.5%. This means that discounts and/or surcharges or payment type fees are limited to 2.5% of the transaction price.

Discount Passthrough percentage 970 and Surcharge or payment type fee Passthrough percentage 980 are each specified here as 100%. This means that 100% of any calculated surcharge or payment type fee and 100% of any calculated discount will be passed on to the customer. However, each of these percentages are subject to Discount/Surcharge or payment type fee Threshold 960 and Passthrough Options 950. For example, even though 100% of calculated surcharges or payment type fees are specified to pass through to the customer, Passthrough Options 950 only permit discounts to be passed through. Accordingly, no calculated surcharges or payment type fees will be passed through to the customer. In another example, if a calculated discount for a promotion, such as a coupon for a certain amount, is calculated to exceed 2.5% of the transaction price, only that amount will be passed on to the customer, with the remainder retained by the merchant.

Rewards Point Conversion 990 is specified here as $1 to (1) point. This means that in an optional system where calculation device is used to implement a points-based rewards system, $1 of surcharges or payment type fees may be offset by redeeming 1 point.

Other possible selections for configuration options 910-990 will be evident to those having skill in the art in view of the present disclosure.

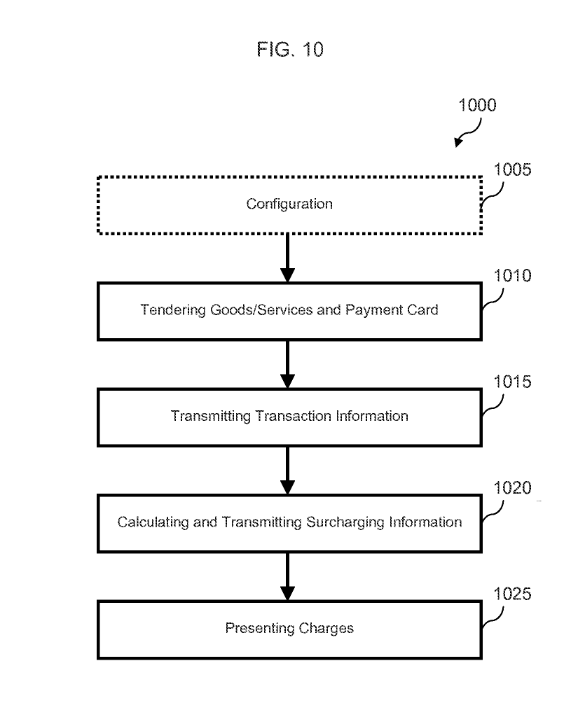

FIG. 10 illustrates a method 1000 which may be implemented using the system shown in FIG. 1, according to aspects the invention.

In optional step 1005, a merchant transmits configuration information to a calculation device. The configuration information may include any such information described herein.

In step 1010, a customer tenders goods and/or services to a merchant device for purchase, and tenders a payment card.

In step 1015, the merchant device transmits transaction information to a calculation device, the transaction information may include the purchase price and information regarding the payment card along with any other information required as further described herein.

In step 1020, the calculation device calculates surcharging or payment type fee information based upon the transaction information, and optionally upon the configuration information, and transmits the surcharging or payment type fee information to the merchant device.

In step 1025, the merchant device calculates any additional price offsets and presents charges to the customer. The charges may include the purchase price of the goods and/or services and a surcharge or payment type fee calculated from the surcharging or payment type fee information, and any other offsets required by the merchant. Optionally, the charges may be presented as a total, listed separately, or partially subtotaled.

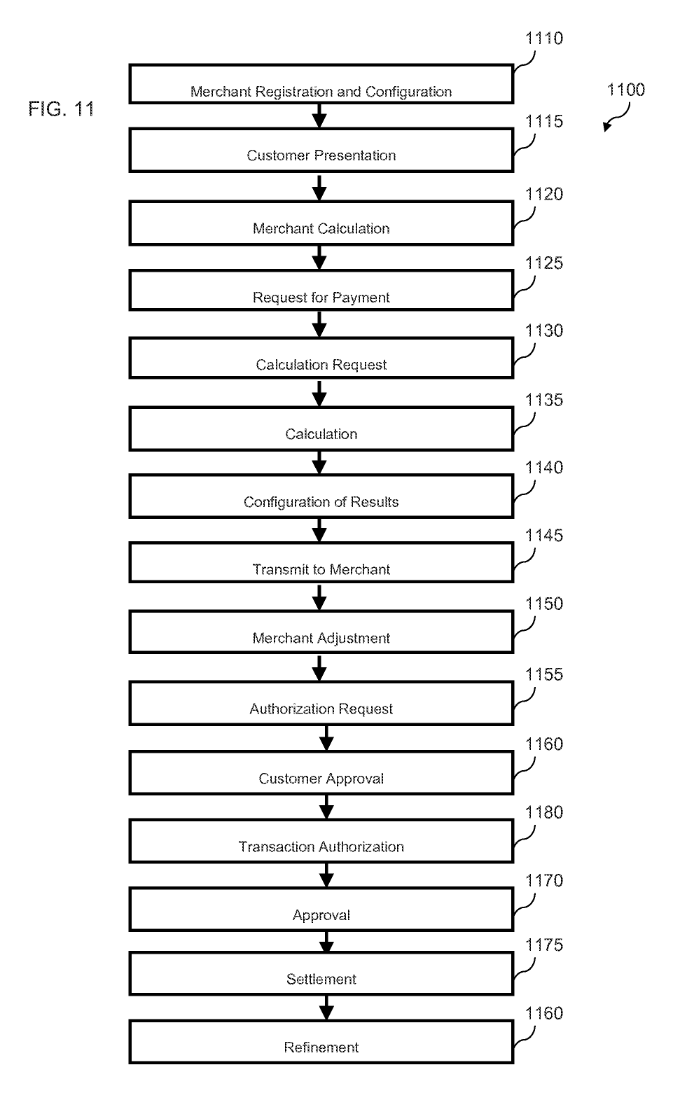

FIG. 11 illustrates a method 1100, including additional steps, which may be implemented using the system shown in FIG. 1, according to aspects of the invention.

Step 1110: Merchant Registration and Configuration

Merchant Registration and Configuration. Each Merchant that uses The calculation device registers to use The calculation device and provides The calculation device information about itself, and how it conducts business. This information includes the following:
a. Merchant Name and billing address
b. Merchant's physical locations
c. Card brands and other payment types accepted
d. Merchant Classification Code registered with each card brand accepted by Merchant
e. Merchant Services Provider Name
f. Merchant Service Provider contract pricing details
g. Acquiring Bank(s)
h. Contract pricing agreements with Acquiring Bank(s)
i. Gateway (if used)
j. Contract pricing agreements with Gateway (if used)
k. Annual transaction volume for each card brand accepted
l. Average Merchant Discount Rate
m. Average Other Merchant Services monthly fees
n. Authorization to receive copies of transaction settlement information from Merchant's Merchant Services Provider
o. State and Local Sales Tax Rates for each Merchant Location
p. Payment acceptance methods (swiped, key entered, card not present)
q. Merchant UCAF (Universal Cardholder Authentication Field) implementation
r. Address Verification utilization
s. CCV Code Verification utilization
t. Merchant Surcharge or payment type fee/Discount/Rewards Points configuration
u. Merchant Surcharge or payment type fee Threshold Fixed Segment configuration (Thresholds identify the separating line between when the cost of processing a particular transaction is either high enough for the Merchant to add a checkout charge proportional to how much the cost of processing is above the Threshold or low enough to provide a checkout discount proportional to how much the cost of processing the transaction is below the Threshold. The Threshold can consist of either a fixed dollar amount regardless of the transaction Initial Total, or a fixed percentage of the transaction Initial Total, or a combination of both a fixed dollar amount (segment) and a fixed percentage (segment).)
v. Merchant Surcharge or payment type fee Threshold Percentage Segment configuration
w. Merchant Discount Threshold Fixed Segment configuration
x. Merchant Discount Threshold Percentage Segment configuration
y. Merchant Surcharge or payment type fee Pass Through Percentage configuration
z. Merchant Discount Pass Through Percentage configuration
aa. Merchant Rewards Points Points Value configuration

Step 1115: Customer Presentation

A Customer presents a transaction consisting of a product or a service or multiple products or services to a Merchant's checkout system

Step 1120: Merchant Calculation

Merchant's checkout system calculates the following amounts:
a. Subtotal (sum of charges for all products and services included in the transaction prior to the application of Sales Taxes)
b. Sales Taxes
c. Other Charges consisting of any Shipping, Handling, or other Fees (not including any Checkout Discounts or Checkout Surcharges or payment type fees as calculated and recommended by The calculation device)
d. Initial Total, consisting of the Transaction Total as calculated by the Merchant Checkout Software prior to receiving the results of a Cost of Acceptance Calculation.

Step 1125: Request for Payment

Merchant's checkout system requests that the Customer provide a method of payment, which if the method of payment is a payment card, includes providing the account numbers to the Merchant by swiping the card, entering the numbers on a website, providing the number to be used for the transaction.

Step 1130: Calculation Request

Merchant's checkout system sends a calculation request to the calculation device including the following information:
a. Merchant's Calculation device ID number
b. Merchant's Location ID number
c. Transaction SubTotal
d. Transaction Sales Taxes
e. Transaction Initial Total
f. Payment Card Bank Identification Number (The BIN is the first 6 or additional digits of the card number for MasterCard, Visa, Discover, and American Express)
g. Products and Services Information indicating the type of products or services that comprise the transaction
h. Configuration Adjustment Information if the Calculation device Merchant Configuration for this particular transaction is to be modified by Calculation device for the current transaction from the standard Calculation device Merchant Configuration.

Step 1135: Calculation

Calculation device receives a calculation request and performs a CardCharge Calculation. The steps for one of the considered methods for performing the calculation are as follows:
a. Calculation device determines the Transaction Expected Interchange Cost.
   i. The BIN (Bank Identification Number) is used to look up in a data table inside Calculation device that matches each BIN to a particular Card Brand and Card Brand Product Type. Calculation device uses the Card Brand Product Type as part of determining which Card Brand Interchange Rate Classification will be assigned to the transaction. This list matching BIN's to Card Brand Product Types is compiled from Issuing Bank BIN lists and adjusted and augmented through the use of transaction settlement information involving Payment Cards with various BIN's.
   ii. Card Brand Product Type is looked up in data table inside Calculation device that matches the Card Brand Product Type to one of the Card Brand Interchange Rate Classifications in the Calculation device list of Card Brand Interchange Rate Classifications. This list is compiled from Interchange Rate Classification Lists publicized by the various Card Brands and adjusted and augmented through the use of transaction settlement information involving various Card Brand Card Types. Calculation device matches the Card Brand Product type to an Initial Card Brand Interchange Rate Classification for possible qualification for the transaction. The Initial Card Brand Interchange Rate Classification is the least expensive Card Brand Interchange Rate Classification that the transaction might possibly qualify for. The data table also matches the Card Brand Product Type to the Next Least Expensive Interchange Rate Classification that the transaction might qualify for if the transaction does not qualify for the Least Expensive Card Brand Interchange Rate Classification. This list of Initial Card Brand Interchange Rate Classifications is adjusted and augmented through the use of transaction settlement information involving Card Brand Types of each particular Card Brand.
   iii. Card Brand Interchange Rate Classification qualification requirements are looked up in a data table inside Calculation device that matches Card Brand Interchange Rate Classifications to the qualification criteria that transactions must comply with to be eligible for that particular Rate Classification. Those qualification requirements are stored as a Rate Classification Qualification Algorithm that when processed, determines if the transaction is qualified for the particular Card Brand Interchange Rate Classification. In addition to Rate Classification Qualifying Rules published by Card Brands, The Rate Classification Qualification Algorithm utilizes the following data to determine if the transaction qualifies for a particular Card Brand Rate Classification:
      1. Transaction Initial Total
      2. Transaction Payment Card Bank Identification Number
      3. Calculation device Merchant Configuration Information
      4. Transaction Configuration Adjustment Information
   iv. If the qualification requirements of the Initial Card Brand Interchange Rate Classification are met by the details of the transaction, then that Card Brand Interchange Rate Classification is used by Calculation device for the calculation. If the qualifications are not met, then Calculation device evaluates the next least expensive possible Card Brand Interchange Rate Classification. If the transaction also fails to qualify for that rate classification, Calculation device continues to evaluate successively more expensive possible Card Brand Interchange Rate Classifications until it finds one for which the transaction does qualify.
   v. Rate qualification algorithms are adjusted and augmented through the use of transaction settlement information from various Merchants and with various Card Brand Card Types.
   vi. Once the least expensive qualifying Card Brand Interchange Rate Classification is identified, the fixed rate, variable rate, and rate cap are looked up in a Calculation device data table that matches Card Type Interchange Rate Classifications to their respective rates. A Transaction Expected Interchange Cost is calculated using these fee characteristics, the Transaction Initial Total and the Sales Taxes. Depending on the Merchant Discount and Surcharge or Payment Type Fee Configuration, the Transaction Expected Interchange Cost calculation may involve a calculated adjustment to the Merchant's Sub Total and Sales Taxes and Initial Total amounts. In these cases, the recommended adjustments are taken into consideration in calculating the Transaction Expected Interchange Cost.
b. Calculation device determines the Transaction Expected Merchant Services Provider Cost.
   i. The Merchant ID Number and Merchant Location Number are used to look up a Merchant Services Provider Algorithm that is used to calculate the Expected Merchant Service Provider Cost for the transaction. The Merchant Services Provider Algorithm for each Merchant is based on their contractual relationship with their Merchant Services Provider. The Merchant Services Provider Algorithm is adjusted over time, if necessary, through the use of transaction settlement information from transactions of the Merchant.
   ii. Monthly fees and per transaction fees charged by Calculation device for services provided to each Merchant may be charged to the Merchant's Merchant Services Provider and passed through to the Merchant as part of the Merchant Services Providers's charges to the Merchant for transaction processing. The Merchant Services Provider Algorithm takes these fees into account.
   iii. The Merchant Services Provider Algorithm is applied to the transaction and an Expected Merchant Services Provider Expected Cost is calculated for the transaction.
c. Calculation device determines the Transaction Expected Other Transaction Cost.
   i. The Merchant Id Number and Merchant Location Number are used to look up an Other Transaction Costs Algorithm that is used to calculate any other costs incurred by the Merchant for Payment transaction processing. This Algorithm takes into account fees charged to the Merchant in addition to Card Brand Interchange fees and Merchant Services Provider fees. These Other Transaction cost may include Card Network assessments and fees charged directly to Merchants by Gateways or other providers of transaction authorizing and processing services and may also include the fees charged by Calculation device to either the Merchant directly or through its Merchant Services Provider
   ii. Other Transaction Costs Algorithm is applied to the transaction and the Transaction Expected Other Transaction Cost is calculated for the transaction.
d. The CardCharge is calculated by adding together the Transaction Expected Interchange Cost, the Transaction Expected Merchant Services Provider Cost, and the Transaction Expected Other Transaction Cost. The CardCharge is Calculation device's prediction of the actual costs that the Merchant will bear for processing the transaction if the transaction is completed by the Customer and processed by the Merchant.

Step 1140: Configuration

The calculation device configures the Calculation Results of the Calculation for presentation to the Merchant according to the Merchant Configuration Settings. The Calculation Results may include any or all of the following:
a. The Surcharge or Payment Type Fee, including any offsets, as calculated by Calculation device
b. A suggested Checkout Discount or Checkout Rebate for the Merchant to provide to the Customer, should the Customer proceed with the transaction, as a way of passing along some or all of the savings associated with the Customer using a Payment Method with a low Surcharge or Payment type fee, including any offsets, for the transaction. The Checkout Discount or Checkout Rebate amount is subtracted from the Initial Total. The Transaction Total and if necessary, the SubTotal and Taxes are recalculated by the Merchant's Checkout Software to reflect the lower cost of the products and services that comprise the transaction as a result of the Checkout Discount or Checkout Rebate, should the Customer proceed with the transaction.
c. A suggested amount of Bonus Rewards Points for the Merchant to provide to the Customer, should the Customer proceed with the transaction, as a way of providing value to the Customer in exchange for using a Payment Method with a low transaction cost, including any offsets.
d. A suggested amount of Checkout Surcharge, Payment Type Fee or Processing Cost Contribution for the Merchant to assess to the transaction that the Customer will pay in addition to the Initial Total, should they proceed with the transaction. The Checkout Surcharge, Payment Type Fee or Processing Cost Contribution is added to the Initial Total by the Merchant's Checkout Software and, if necessary, the SubTotal and Sales Taxes are adjusted accordingly.
e. A suggested amount of Checkout Charge for the Merchant to assess to the transaction that is unrelated to the payment method chosen by the customer. In some situations, providing the Customer with both a Checkout Charge that is unrelated to Payment Type as well as a Checkout Discount or Checkout Rebate that is calculated based on the Payment Type and the cost of processing that payment type will allow Merchants to pass along the proportional costs associated with Payment Cards with high Surcharge, including any offsets, even in some localities that have regulations prohibiting surcharges on credit cards or payment methods
f. A range of hypothetical Surcharge or Payment type fees, including any offset, that would be calculated for the transaction across the full range of Card Brands, Card Brand Card or Check Types accepted by the Merchant. In some Merchant Configurations, the Merchant Checkout Software would display this Range of surcharges or Payment type fees, including any offsets to the Customer to help inform the Customer about where the Payment type selected by the Customer fits within the range of costs to the Merchant for processing various Payment types.
g. An advertisement to display to the Customer.

Step 1145: Transmit to Merchant

The Calculation Results are sent to the Merchant.

Step 1150: Merchant Adjustment

The Merchant Checkout Software Receives the Calculation and adjusts various components of Customer Checkout Information. The Merchant Checkout Software recalculates the Transaction Total, SubTotal, and Sales Taxes if appropriate, as well any other information to be displayed to the Customer as a result of the Calculation Results.

Step 1155: Authorization Request

The Merchant Checkout Software displays the adjusted Customer Checkout Information to the Customer and requests Customer Authorization for the transaction.

Step 1160: Customer Approval
a. If the Customer approves the transaction, the sale is completed.
b. If the Customer chooses not to approve the transaction, the Customer may choose to resume the transaction with a new choice of Payment Type or Payment Card, which would result in a new Calculation Request.

Step 1165: Transaction Authorization

If the Customer approves the transaction, The Merchant Checkout Software sends a Transaction Authorization Request electronically to the Merchant's Gateway or Merchant Services Processor or Calculation device. This Transaction Authorization Request utilizes the Card Brand Network or other Network to connect to the Issuing Bank for transaction authorization.

Step 1170: Approval

The Merchant's Checkout Software receives an Authorization Result from the Merchant's Gateway or Merchant Services Provider or Calculation device and if the Authorization Result is “Approved”, the transaction is complete and the Merchant's Checkout Software prepares and presents a transaction receipt to the customer. The transaction receipt may include information received or calculated from information received in the Calculation Result.

Step 1175: Settlement

At the end of each day, or for some Merchants, several times per day, the various completed transactions are assembled into a Batch and electronically sent to the Merchant's Acquiring Bank, Calculation device or other Processor for Settlement with the Issuing Bank.

Step 1180: Refinement

After Settlement, the Merchant's Merchant Services Provider receives Transaction Settlement Information from the Acquiring Bank or other Processor and makes that settlement information available to the Merchant and to Calculation device. Calculation device utilizes this settlement information to recursively adjust the tables, algorithms, and methods of calculating surcharges or payment type fees to continuously improve the accuracy of those calculations.

Although the invention has been described with reference to a particular arrangement of parts, features and the like, these are not intended to exhaust all possible arrangements or features, and indeed many modifications and variations will be ascertainable to those of skill in the art.

What is claimed is:

1. A payment cost of acceptance calculation system comprising:
a calculation device which includes a processor and which is configured to communicate with a client device;
software executing on the processor for receiving a request to calculate a cost of acceptance for a transaction from the client device, calculating a calculated cost of acceptance for the transaction, and transmitting the calculated cost of acceptance to the client device.

2. The system of claim 1, wherein the calculated cost of acceptance is an estimate of the actual cost of acceptance that would apply to the transaction upon completion of the transaction.

3. The system of claim 1, wherein the calculated cost of acceptance is equal to the actual cost of acceptance that would apply to the transaction upon completion of the transaction.

4. The system of claim 1, wherein said calculation device receives the request prior to a request for authorization of the transaction.

5. The system of claim 1, wherein the calculated cost of acceptance is calculated using a BIN number for a payment card used for the transaction.

6. The system of claim 1, wherein the calculated cost of acceptance is calculated using only a BIN number for a payment card used for the transaction and a merchant identification number and a transaction amount as inputs.

7. The system of claim 1, wherein the transaction is an e-commerce transaction.

8. The system of claim 1, wherein the transaction is conducted at a POS terminal.

9. The system of claim 1, wherein the client device applies a modification to the transaction based upon the calculated cost of acceptance.

10. The system of claim 1, wherein the modification is a surcharge, discount, or pass-through fee.

11. The system of claim 1, wherein the client device adjusts a number of awards points based upon the calculated cost of acceptance.

12. The system of claim 1, wherein the client device receives price and payment card information from a customer, and provides a surcharge to the customer for approval based upon the calculated cost of acceptance.

13. The system of claim 1, wherein the client device provides a reduced surcharge to the customer when the customer views an advertisement.

14. The system of claim 1, wherein the client device provides a reduced surcharge to the customer when the customer completes a survey.

15. The system of claim 1, wherein the client device provides a reduced surcharge to the customer when the customer provides marketing information.

16. The system of claim 1, wherein the client device is configured to accept a selection of a payments processor from among at least two payments processors, and wherein said calculation device is configured to receive the selection from the client device and to calculate the calculated cost of acceptance based on the selection.

17. The system of claim 1, wherein said calculation device calculates the calculated cost of acceptance based on a transaction cost.

18. The system of claim 1, wherein said calculation device calculates the calculated cost of acceptance based on an estimated transaction cost.

19. The system of claim 1, wherein said calculation device calculates the calculated cost of acceptance based on a historical transaction cost.

20. The system of claim 1, wherein said calculation device calculates the calculated cost of acceptance based upon a statistical analysis of a plurality of historical transaction costs.

21. The system of claim 1, wherein said calculation device calculates the calculated cost of acceptance as an average of at least two historical transaction costs.

22. The system of claim 1, wherein said calculation device calculates the calculated cost of acceptance based on an iteratively refined model of transaction costs.

23. The system of claim 1, wherein said calculation device records actual transaction costs after a settlement of the transaction.

24. The system of claim 1, wherein said calculation device calculates the calculated cost of acceptance based on a median of at least three historical transaction costs.

25. The system of claim 1, wherein said calculation device receives an actual transaction cost for the transaction and calculates the calculated cost of acceptance based upon the actual transaction cost.

26. The system of claim 1, wherein said calculation device communicates a price and payment information to a payment network device and receives actual transaction costs from the payment network device prior to calculating the calculated cost of acceptance.

27. The system of claim 1, wherein said calculation device receives at least a portion of an actual transaction cost for the transaction and calculates at least a portion of the calculated cost of acceptance based upon the portion of the actual transaction cost.

28. The system of claim 1, wherein said calculation device calculates the calculated cost of acceptance based on a percentage of a price of the transaction.

29. The system of claim 1, wherein said calculation device calculates the calculated cost of acceptance based on a fixed percentage of a price of the transaction.

30. The system of claim 1, wherein said calculation device calculates the calculated cost of acceptance based upon a metric selected from the group consisting of an interchange rate; an interchange rate category; an interchange fee; a merchant discount rate; a merchant discount fee; a calculation rate; and a calculation fee.

31. The system of claim 1, wherein said calculation device calculates the calculated cost of acceptance based upon a metric selected from the group consisting of a merchant billing address; a merchant physical location; a merchant classification code; a merchant services provider contract; an acquiring bank contract; a gateway contract; and an annual transaction volume.

32. The system of claim 1, wherein said calculation device is integrated with the client device.

33. The system of claim 1, wherein said calculation device is configured to communicate with the client device over a network.

34. A payment system comprising:
a calculation device which includes a processor; and,
a client device configured to
receive a price and payment information for a transaction;
transmit the price and the payment information to the calculation device;
receive surcharge information from the calculation device that is determined based upon the price and the payment card information; and,
determine a surcharge based on the surcharge information.

35. The system of claim 34, wherein the client device receives the price and payment card information from a customer, and provides the surcharge to the customer for approval.

36. The system of claim 34, wherein the client device provides a reduced surcharge to the customer when the customer views an advertisement.

37. The system of claim 34, wherein the client device provides a reduced surcharge to the customer when the customer completes a survey.

38. The system of claim 34, wherein the client device provides a reduced surcharge to the customer when the customer provides marketing information.

39. The system of claim 34, wherein the calculation device calculates the surcharge information based on a transaction cost.

40. The system of claim 34, wherein the calculation device calculates the surcharge information based on an estimated transaction cost.

41. The system of claim 34, wherein the calculation device calculates an estimated transaction cost.

42. The system of claim 34, wherein the calculation device calculates the surcharge information based on a historical transaction cost.

43. The system of claim 34, wherein the calculation device calculates the surcharge information based upon a statistical analysis of a plurality of historical transaction costs.

44. The system of claim 34, wherein the calculation device calculates the surcharge as an average of at least two historical transaction costs.

45. The system of claim 34, wherein the calculation device calculates the surcharge based on an iteratively refined model of the transaction cost.

46. The system of claim 34, wherein the calculation device records actual transaction costs after the settlement of a transaction.

47. The system of claim 34, wherein the calculation device calculates the surcharge as a median of at least three historical transaction costs.

48. The system of claim 34, wherein the calculation device receives an actual transaction cost for the transaction and calculates the surcharge based upon the actual transaction cost.

49. The system of claim 34, wherein the calculation device communicates the price to a card network device and receives actual transaction costs from the card network device prior to calculating the surcharge.

50. The system of claim 34, wherein the calculation device receives at least a portion of an actual transaction cost for the transaction and calculates at least a portion of the surcharge based upon the portion of the actual transaction cost.

51. The system of claim 34, wherein the calculation device calculates the surcharge information based on a percentage of the price.

52. The system of claim 34, wherein the calculation device calculates the surcharge information based on a fixed percentage of the price.

53. The system of claim 34, wherein the calculation device calculates the surcharge information based upon a metric selected from the group consisting of an interchange rate; an interchange rate category; an interchange fee; a merchant discount rate; a merchant discount fee; a calculation rate; and a calculation fee.

54. The system of claim 34, wherein the calculation device calculates the surcharge information based upon a metric selected from the group consisting of a merchant billing address; a merchant physical location; a merchant classification code; a merchant services provider contract; an acquiring bank contract; a gateway contract; and an annual transaction volume.

55. The system of claim 34, wherein the calculation device is integrated with the authorization device.

56. The system of claim 34, wherein the calculation device is configured to communicate with the authorization device over a network.

57. The system of claim 34, wherein the client device is configured to accept a selection of a payment processor from among at least two payments processors, and to transmit the selection to the calculation device for calculating the surcharge.

58. A payment surcharging system comprising:
a calculation device which includes a processor and which is configured to
receive a price and payment information for a transaction from a client device;
calculate surcharge information based upon the price and payment information; and,
transmit the surcharge information to the client device.

59. A method for surcharging a payment transaction which comprises:
providing a calculation device having a processor; and,
providing a client device configured to
receive a price for a transaction and receive payment information;
transmit the price and the payment information to the calculation device;
receive surcharge information from the calculation device that is determined based upon the price and the payment information;
and, determine a surcharge based on the surcharge information.

60. A payment surcharging system comprising:
a calculation device which includes a processor and which is configured to calculate surcharge information based upon a price, payment information, and a transaction cost; and,
a client device which includes a second processor, which is configured to communicate with the calculation device and to
receive the price and payment information from a customer;
transmit the price and the payment information to the calculation device;
receive surcharge information from the calculation device;
determine a surcharge based on the surcharge information;
display the surcharge to the customer for approval; and,
receive an authorization from the customer.
